(19) United States
(12) Patent Application Publication
(10) Pub. No.: US 2015/0016904 A1
(43) Pub. Date: Jan. 15, 2015

(54) COMBINATION-TYPE MACHINING TOOL

(71) Applicant: TOPGREEN TECHNOLOGY CO., LTD., New Taipei City (TW)

(72) Inventor: Ping-Da LIN, New Taipei City (TW)

(21) Appl. No.: 13/941,170

(22) Filed: Jul. 12, 2013

(51) Int. Cl. B23G 5/20; B23C 5/22; B23C 5/20; B23C 5/00; B23C 5/10

(52) U.S. Cl. CPC B23G 5/20; B23C 5/006; B23C 5/109; B23C 5/20; B23C 5/22; B23G 2200/02; B23G 2200/06; B23G 2200/145; B23C 2210/02
USPC 408/26

(57) ABSTRACT

A combination-type machining tool has a handle segment and a head segment. The handle segment is made of stainless steel or carbon steel and has a clamping handle and a body. The body is axially formed on and protrudes from a front end of the clamping handle and has a protruding rod axially formed on and protruding from a front side of the body. The head segment is made of tungsten steel, is mounted around the protruding rod and has a through hole axially formed through a front side and a rear side of the head segment, and an inner peripheral surface of the through hole is securely mounted around the protruding rod to enable the rear side of the head-segment to abut against the front side of the body.

### BACKGROUND OF THE INVENTION

1. Field of the Invention

The present inventions relates to a machining tool, and more particularly to a combination-type machining tool that can be used for tapping threads and milling.

2. Description of Related Art

Shapes of the heads of the machining tools are formed according to different functions. For example, a machining tool with a pointed head is used to drill holes on a workpiece. In addition, a machining tool with a flat head is used for tapping threads or milling in the holes of the workpiece. With reference to FIG. 5, a conventional machining tool 50 that is used to form a threaded hole has a clamping handle 51 and a shank 52. The clamping handle 51 may be made of stainless steel or carbon steel and has a front end. The shank 52 may be made of tungsten steel, is axially formed on and protrudes from the front end of the clamping handle 51 and has a body 520 and a head 521. The body 520 is axially formed on and protrudes from the front end of the clamping handle 51 and has a front end. The head 521 is axially formed on and protrudes from the front end of the body 520 by welding and has a front end, an external surface, an outer thread and a fluted slot 522. The outer thread is spirally formed on the external surface of the head 521 from the front end of the head 521 to the front end of the body 520. The fluted slot 522 is spirally formed in the external surface of the head 521 parallel to the outer thread.

In use, the clamping handle 51 of the conventional machining tool 50 is mounted in and clamped by a chuck of a processing machine, and the head 521 of the shank 52 is aimed at a workpiece. When the clamping handle 51 is rotated with the chuck, an inner threaded hole can be formed in the workpiece by the head 521 of the shank 52. During the drilling process, the scraps of the workpiece can be discharged from the inner threaded hole by the fluted slot 522 of the shank 52.

Since the clamping handle 51 of the conventional machining tool 50, when in use, is rotated to tap threads so as to form the inner threaded hole in the workpiece, the clamping handle 51 is mostly made of stainless steel or carbon steel to bear a larger torque. In order to form an inner threaded hole efficiently in a workpiece by the shank 52, the shank 52 is made of tungsten steel to provide a preferred quality of the threads of the inner threaded hole and to have a long service life.

Though the conventional machining tool 50 has the torsion-resistant feature of stainless steel or carbon steel and the high hardness feature of tungsten steel, the body 520 of the shank 52 must have a certain length to allow forming an inner threaded hole in a workpiece. During the drilling process, the shank 52 that is made of tungsten steel with hard and brittle texture cannot bear the rotating torque and may be broken easily, and this will affect the thread quality of the inner threaded hole and cause wearing and tearing of the conventional machining tool 50 and also increase the danger in use.

To overcome the shortcomings, the present invention provides a combination-type machining tool to mitigate or obviate the aforementioned problems.

### SUMMARY OF THE INVENTION

The main objective of the present invention is to provide a combination-type machining tool that can be used for tapping threads and milling.

The combination-type machining tool in accordance with the present invention has a handle segment and a head segment. The handle segment is made of stainless steel or carbon steel and has a clamping handle and a body. The body is axially formed on and protrudes from a front end of the clamping handle and has a protruding rod axially formed on and protruding from a front side of the body. The head segment is made of tungsten steel, is mounted around the protruding rod and has a through hole axially formed through a front side and a rear side of the head segment, and an inner peripheral surface of the through hole is securely mounted around the protruding rod to enable the rear side of the head segment to abut against the front side of the body.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a combination-type machining tool in accordance with the present invention;

FIG. 2 is an exploded and cross-sectional side view of the combination-type machining tool in FIG. 1;

FIG. 3 is an enlarged and cross-sectional side view of the combination-type machining tool in FIG. 2;

FIG. 4 is an enlarged cross-sectional side view of the combination-type machining tool in FIG. 1; and

FIG. 5 is a perspective view of a conventional machining tool in accordance with the prior art.

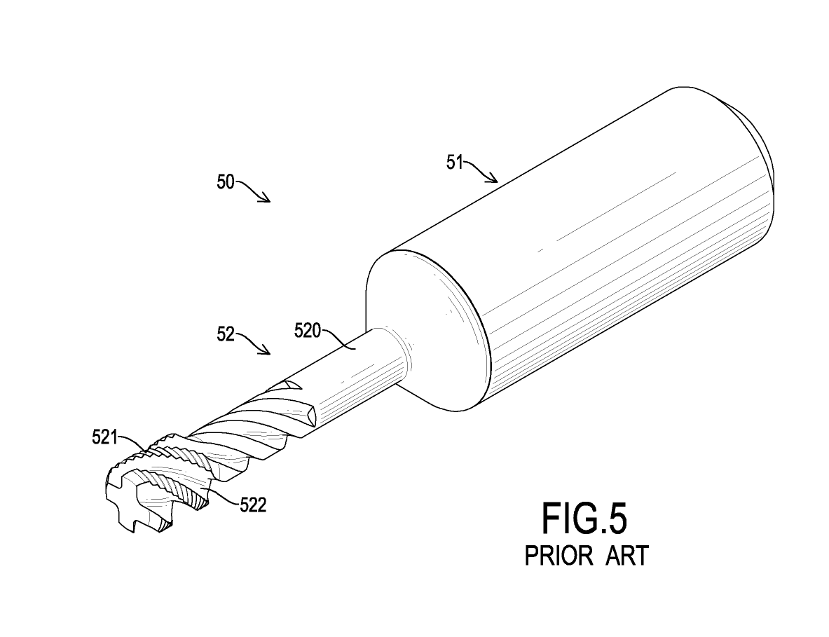

### DETAILED DESCRIPTION OF THE PREFERRED EMBODIMENT

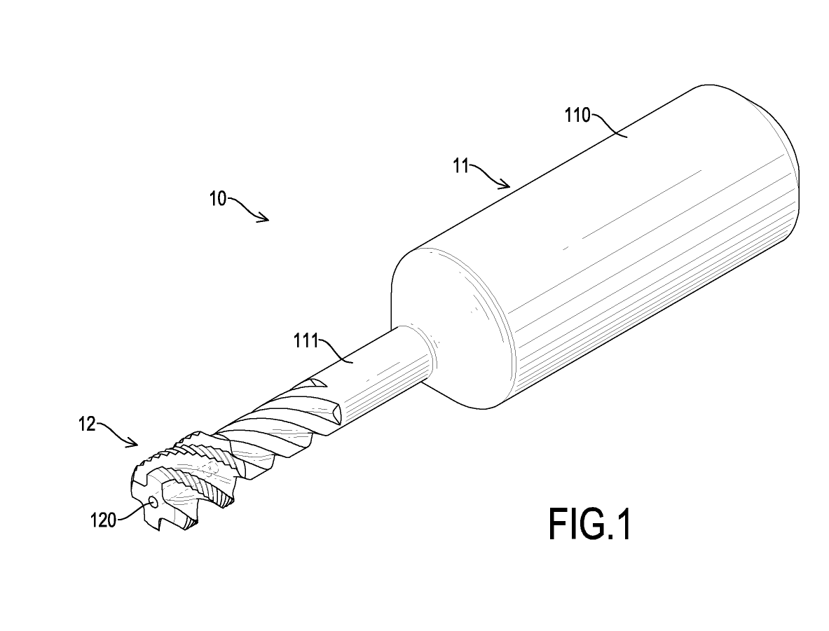

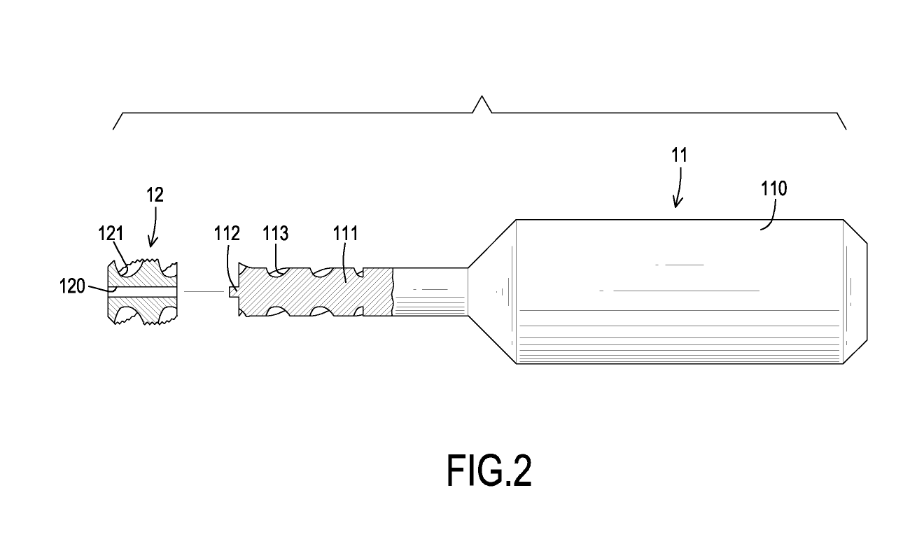

With reference to FIGS. 1 and 2, a combination-type machining tool 10 in accordance with the present invention has a handle segment 11 and a head segment 12. The handle segment 11 is integrally made of stainless steel or carbon steel and has a clamping handle 110 and a body 111. The clamping handle 110 is cylindrical and has a front end and a diameter. The body 111 is axially formed on and protrudes from the front end of the clamping handle 110 and has a length L1, a diameter, an external surface, a front side, a protruding rod 112 and multiple handle-fluted slots 113. The diameter of the body 111 is smaller than the diameter of the clamping handle 110. The protruding rod 112 may be cylindrical or polygonal, is axially formed on and protrudes from the front side of the body 111 and has at least one abutting face. The handle-fluted slots 113 are spirally formed in the external surface of the body 111 at intervals.

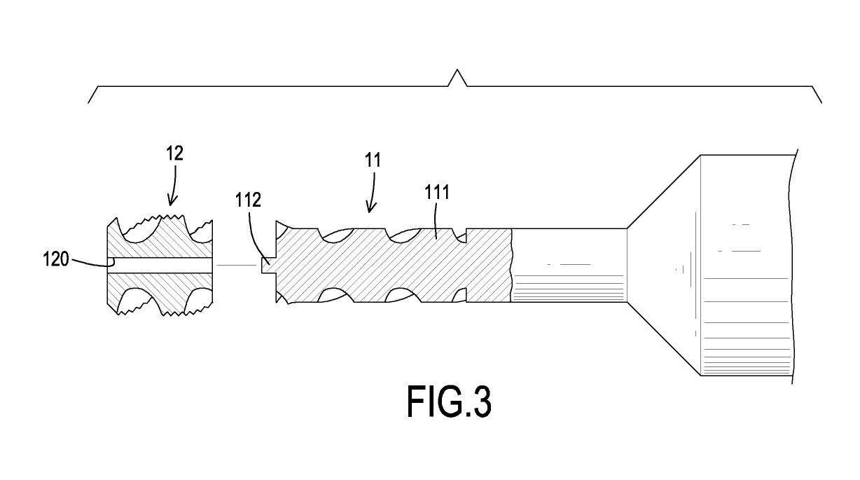

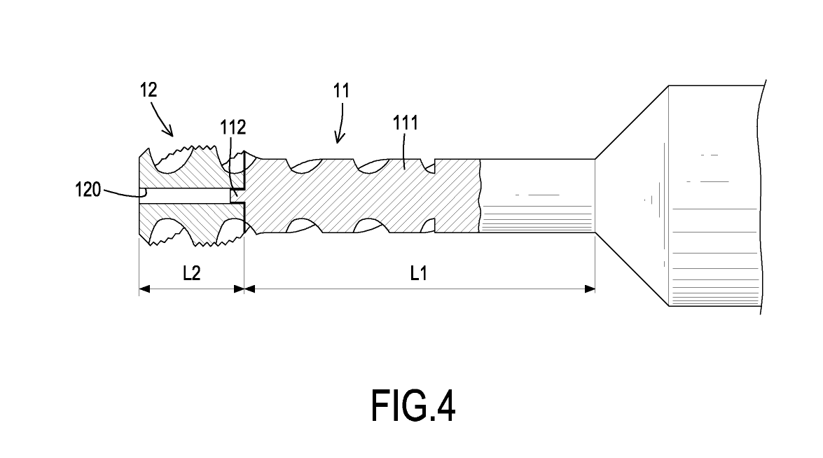

With reference to FIGS. 3 and 4, the head segment 12 is made of tungsten steel, is mounted around the protruding rod 112 of the handle segment 11 and has a front side, a rear side, an external surface, a length L2, a through hole 120 and multiple head-fluted slots 121. The rear side of the head segment 12 is securely mounted in and abuts against the front side of the body 111 by welding. The length L2 is shorter than half of a sum of the length of the body 111 of the handle segment 11 and the length of the head segment 12 (i.e. L2<1/2(L1+L2)). The through hole 120 is axially formed through the front side and the rear side of the head segment 12 and an inner peripheral surface of the through hole 120 is securely mounted around the protruding rod 112 to enable the rear side of the head segment 12 to abut against the front side of the body 111. Furthermore, during the welding process, the expanding gas in the head segment 12 can be discharged from the through hole 120 to enable the head segment 12 to securely connect to the handle segment 11. In addition, the at least one abutting face of the protruding rod 112 abuts against the head segment 12 in the through hole 120 to prevent the head segment 12 from rotating relative to the handle segment 11. The head-fluted slots 121 are spirally formed in the external surface of the head segment 12 and respectively communicate with the handle-fluted slots 113 of the handle segment 11 when the head segment 12 is securely connected to the handle segment 11.

The length L1 of the head segment 12 of the combination-type machining tool in accordance with the present invention is shorter than half of the sum of the length of the handle segment 11 and the length of the head segment 12. Also, the head segment 12 is made of tungsten steel of high hardness and the handle segment 11 is made of stainless steel or carbon steel of high torque-resistance. As such, the head segment 12 and the body 111 of the handle segment 11 have features of high hardness and high torque-resistance at the same time to enhance the structural strengths of the head segment 12 and the body 111 of the handle segment 11 to be stronger than the shank 52 of the conventional machining tool 50. Therefore, the body 111 of the handle segment 11 that is made of stainless steel or carbon steel has a high torsion-resistant feature to prevent the combination-type machining tool in accordance with the present invention from breaking during a drilling process, and the head segment 12 that is made of tungsten steel has a high hardness feature to provide a preferred thread quality of an inner threaded hole and to have a service long life.

Furthermore, as the rear side of the head segment 12 is securely mounted on and abuts against the front side of the body 111 by welding and the protruding rod 112 of the body 111 is mounted in the through hole 120 and abuts against the head segment 12, enhanced connecting strength and stability can be provided to the head segment 12 and the handle segment 11.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combination-type machining tool having:
a handle segment made of stainless steel or carbon steel and having
a clamping handle having a front end and a diameter; and
a body axially formed on and protruding from the front end of the clamping handle and having
a diameter being smaller than the diameter of the clamping handle;
an external surface;
a front side; and
a protruding rod axially formed on and protruding from the front side of the body; and
a head segment made of tungsten steel, mounted around the protruding rod of the handle segment and having
a rear side securely mounted in and abutting against the front side of the body;
a front side;
an external surface; and
a through hole axially formed through the front side and the rear side of the head segment and having an inner peripheral surface securely mounted around the protruding rod to enable the rear side of the head segment to abut against the front side of the body.

2. The combination-type machining tool as claimed in claim 1, wherein
the body of the handle segment has a length; and
the head segment has a length being shorter than half of a sum of the length of the head segment and the length the body of the handle segment.

3. The combination-type machining tool as claimed in claim 2, wherein
the body of the handle segment has multiple handle-fluted slots spirally formed in the external surface of the body at intervals; and
the head segment has multiple head-fluted slots spirally formed in the external surface of the head segment and respectively communicating with the handle-fluted slots of the handle segment when the head segment is securely connected to the handle segment.

4. The combination-type machining tool as claimed in claim 1, wherein
the body of the handle segment has multiple handle-fluted slots spirally formed in the external surface of the body at intervals; and
the head segment has multiple head-fluted slots spirally formed in the external surface of the head segment and respectively communicating with the handle-fluted slots of the handle segment when the head segment is securely connected to the handle segment.

5. The combination-type machining tool as claimed in claim 1, wherein the protruding rod has at least one abutting face abutting against the head segment in the through hole to prevent the head segment from rotating relative to the handle segment.

6. The combination-type machining tool as claimed in claim 2, wherein the protruding rod has at least one abutting face abutting against the head segment in the through hole to prevent the head segment from rotating relative to the handle segment.

7. The combination-type machining tool as claimed in claim 3, wherein the protruding rod has at least one abutting face abutting against the head segment in the through hole to prevent the head segment from rotating relative to the handle segment.

8. The combination type machining tool as claimed in claim 4, wherein the protruding rod has at least one abutting face abutting against the head segment in the through hole to prevent the head segment from rotating relative to the handle segment.
